(19) United States
(12) Patent Application Publication
(10) Pub. No.: US 2005/0065627 A1
(43) Pub. Date: Mar. 24, 2005

(54) Batch order change system

(75) Inventors: Kung-Cheng Tu, Hsinchu (TW); Yu-Chen Chuang, Hsinchu (TW); Ya-Ping Yeh, Hsinchu (TW)

Correspondence Address: Finnegan, Henderson, Farabow,;Garrett & Dunner, L.L.P., 1300 I Street, N.W., Washington, DC, 20005-3315, US

(73) Assignee: Macronix International Co., Ltd.

(21) Appl. No.: 10/667,447

(22) Filed: Sep. 23, 2003

(51) Int. Cl. G06F 19/00

(52) U.S. Cl. 700/100

(57) ABSTRACT

A system for manufacturing a plurality of products that comprises a plurality of product attributes respectively corresponding to the products, a first text file including a plurality of amendment entries for amending the product attributes, an agent reading the first text file and the amendment entries, a scheduling subsystem respectively amending the product attributes according to the amendment entries and determining whether any of the amendment entries fails, and a second text file collecting the failed amendment entries, wherein the agent resends the second text file and the collected failed amendment entries to the scheduling subsystem for further amending the product attributes according to the collected failed amendment entries.

### DESCRIPTION OF THE INVENTION

1. Field of the Invention

This invention relates in general to data processing and, more particularly, to a method of data processing in a manufacturing execution system.

2. Background of the Invention

A manufacturing execution system (“MES”) is an on-line integrated computerized system that includes methods and tools to implement production. A general MES may provide functions such as collecting data in real time, organizing and storing data in a centralized database, making data accessible throughout a network, and integrating critical data from other information systems such as planning and accounting. Semiconductor fabs or liquid crystal display (“LCD”) plants generally employ MES to facilitate planning and scheduling in microelectronics manufacturing processes. MES may support product tracking, scheduling, automation, quality control, floor monitoring and real time reporting, and managing multiple parallel manufacturing lines as well as multiple subcontractor facilities.

A scheduling sub-system of an MES in the art provides an order change function, which allows a user to amend an order by entering an amended attribute of wafers in a series of lots. The user must manually input the entries one by one into the scheduling sub-system for amendment. The manual approach in the art is hardly practicable today because a fab or an LCD plant may produce several hundreds or even thousands of such entries. In addition, the user must re-enter entries that fail in an amendment, where system performance severely degrades when the success rate of amendment is particularly low.

### SUMMARY OF THE INVENTION

Accordingly, the present invention is directed to a method that obviates one or more of the problems due to limitations and disadvantages of the related art.

To achieve these and other advantages, and in accordance with the purpose of the invention as embodied and broadly described, there is provided a system for manufacturing a plurality of products that comprises a plurality of product attributes respectively corresponding to the products, a first text file including a plurality of amendment entries for amending the product attributes, an agent reading the first text file and the amendment entries, a scheduling subsystem respectively amending the product attributes according to the amendment entries and determining whether any of the amendment entries fails, and a second text file collecting the failed amendment entries, wherein the agent resends the second text file and the collected failed amendment entries to the scheduling subsystem for further amending the product attributes according to the collected failed amendment entries.

In one aspect, the first text file and the second text file further comprises generally the same text file format.

In another aspect, the amendment entries are further divided into a plurality of batches and the product attributes are amended on a batch-by-batch basis.

Also in accordance with the present invention, there is provided a method for manufacturing a plurality of products having a plurality of corresponding product attributes, the method comprising the steps of providing a first text file including a plurality of amendment entries for amending the product attributes, reading the first text file and the amendment entries into a scheduling subsystem, amending the product attributes according to the amendment entries, determining if any of the amendment entries fails the amendment, collecting the failed amendment entries in a second text file, resending the second text file to the scheduling subsystem, and further amending the product attributes according to the failed amendment entries.

Still in accordance with the present invention, there is provided a method for manufacturing a plurality of products having a plurality of corresponding product attributes, the method comprising the steps of providing a first text file including a plurality of amendment entries for amending the product attributes, dividing the amendment entries into a plurality of batches, importing the first text file and the amendment entries into a scheduling subsystem, amending the product attributes according to the amendment entries on a batch-by-batch basis, determining if any of the amendment entries fails the amendment, collecting the failed amendment entries in a second text file, importing the second text file to he scheduling subsystem, and further amending the product attributes according to the failed amendment entries on a batch-by-batch basis.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawing, which is incorporated in and constitutes a part of this specification, illustrates several embodiments of the invention and together with the description, serves to explain the principles of the invention.

### BRIEF DESCRIPTION OF THE DRAWINGS

FIG. 1 is a flow chart of a method of data processing in accordance with one embodiment of the present invention; and

FIG. 2 is a schematic diagram of a manufacturing execution system in accordance with one embodiment of the present invention.

### DESCRIPTION OF THE EMBODIMENTS

Reference will now be made in detail to the present embodiment of the invention, an example of which is illustrated in the accompanying drawings. Wherever possible, the same reference numbers will be used throughout the drawings to refer to the same or like parts.

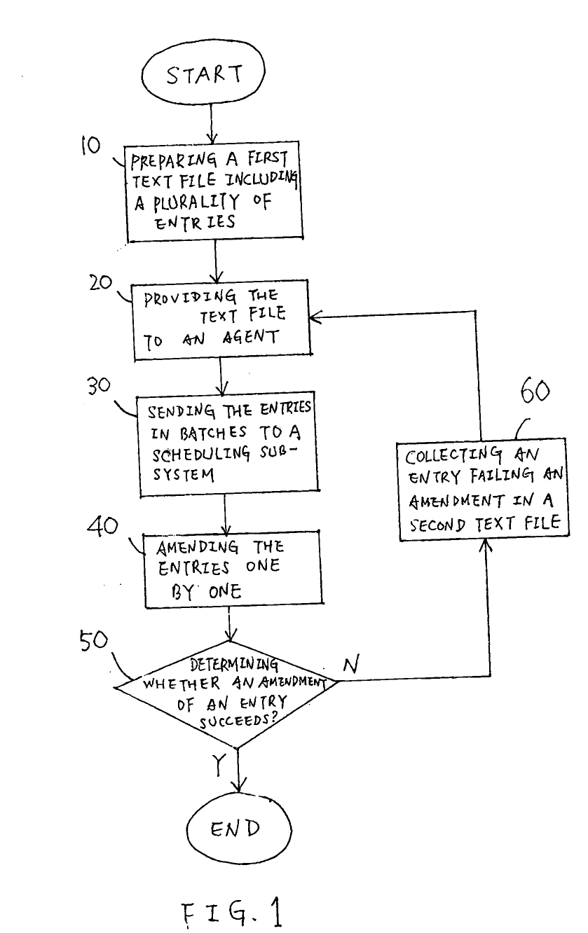

FIG. 1 is a flow chart of a method of data processing according to one embodiment of the present invention. Referring to FIG. 1, in step 10, the method begins with preparing a first text file including a plurality of entries. In one embodiment according to the invention, the first text file includes a format such as a Microsoft™ Word document, which may be prepared by users of, for example, manufacturing departments of a fab or an LCD plant. Each entry includes at least one attribute of a lot to be amended. A single lot of wafers may include approximately 25 pieces of wafers and, for the purpose of manufacturing automation and tracking, is assigned with attributes such as lot identity, product identity, committed due date and lot owners. These attributes are generally stored in a database, and may be subject to change due to modification demanded during manufacturing processes. For example, a customer, either external or internal, may request a change of masks used for a single lot of wafers. As a result, at least one attribute, for example, the product identity, should be amended to comply with manufacturing automation. To facilitate understanding of the present invention, a part of an exemplary first text file format is shown in Table 1 below for reference.

TABLE 1

| | | | Other |
|---|---|---|---|
| Lot_ID | Original PROD_ID | Amended PROD_ID | Attributes |
| 2G816900 | A0740D00 | A0740C00 | |
| 2G817100 | A0740D00 | A0740C00 | |
| 2G801501 | A0740D00 | A0740C00 | |
| 2G818300 | A0740D00 | A0740C00 | |
| 2G832500 | A0740D00 | A0740C00 | |
| 2G836800 | A0740D00 | A0740C00 | |
| 2G822801 | A0740D00 | A0740C00 | |

Table 1 indicates that since the mask used for seven lots of wafers is changed, the product identity has to be amended. A user may prepare a first text file by giving commands in the database.

Next, in step 20, instead of manually inputting the entries, the user provides the first text file to an agent. In one embodiment according to the invention, the agent is a software program for reading the first text file, and dividing the entries into batches.

Subsequent to step 20, in step 30, the entries of a first batch are sent to a scheduling sub-system of a manufacturing execution system. In one embodiment according to the invention, a batch includes approximately 50 entries.

Next, in step 40, the entries of the first batch are amended one by one in the scheduling sub-system. In one embodiment, the amendment is implemented by the order function provided by the scheduling sub-system in the MES.

Next, in step 50, the scheduling sub-system determines whether an amendment of an entry is successful. If the entry is successful, the amendment process for an entry comes to an end. If not, in step 60, the entry fails the amendment is collected in a second text file. In one embodiment according to the invention, the second text file includes generally the same format as the first text file.

Entries collected in the second text file are not sent to the scheduling subsystem until all the subsequent batches of entries are amended. Therefore, the steps of amending (step 40), determining (step 50) and collecting (step 60) are repeated for the subsequent batches of entries. When all the entries prepared in the first text file are amended or collected, the second text file is then sent to the agent. The agent divides the entries collected in the second text file into batches, and sending the entries in batches to the scheduling sub-system for amendment.

If the MES does not support a real time order change function, an entry of a lot may be directly put into the second text file by a user if the lot is found to be held in a manufacturing process.

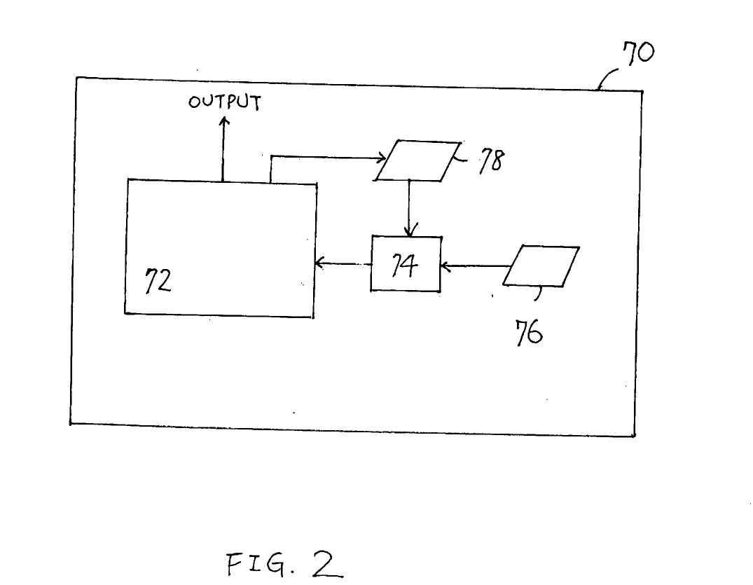

FIG. 2 shows a schematic diagram of a manufacturing execution system (“MES”) 70 according to one embodiment of the present invention. Referring to FIG. 2, system 70 includes a scheduling subsystem 72, an agent 74, a first text file 76, and a second text file 78. System 10 is provided to manufacture a plurality of products, for example, LCD devices or semiconductor wafers. The products generally include a plurality of corresponding product attributes. In addition to scheduling subsystem 72, system 70 may further include other subsystems such as those for product/process tracking, automation, quality control, floor monitor or reporting (not shown).

In operation, first text file 76, including a plurality of amendment entries for amending the product attributes, is read by agent 74 and sent to scheduling subsystem 72. Supporting an order change function, scheduling subsystem 72 respectively amends the product attributes according to the amendment entries, and determines whether any of the amendment entries fails. A failed amendment entry is collected in second text file 78, and then fed into scheduling subsystem 72 through agent 74 for further amending the product attributes. On the other hand, a successful amendment entry from scheduling subsystem 72 is ready for output. In one embodiment according to the invention, the product attributes are amended according to the amendment entries included in first text file 76 or failed amendment entries included in second text file 78 on a batch-by-batch basis.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A system for manufacturing a plurality of products comprising:
a plurality of product attributes respectively corresponding to the products;
a first text file including a plurality of amendment entries for amending the product attributes;
an agent reading the first text file and the amendment entries;
a scheduling subsystem respectively amending the product attributes according to the amendment entries and determining whether any of the amendment entries fails; and
a second text file collecting the failed amendment entries, wherein the agent resends the second text file and the collected failed amendment entries to the scheduling subsystem for further amending the product attributes according to the collected failed amendment entries.

2. The system of claim 1, the product attributes further comprising product identity, lot identity, commit due time, commit due date, lot order data, lot owner and lot owner department with respect to the products.

3. The system of claim 1, the product further comprising liquid crystal displays (LCDs) and semiconductor wafers.

4. The system of claim 1, the first text file and the second text file further comprising generally the same text file format.

5. The system of claim 1 wherein the amendment entries are further divided into a plurality of batches and the product attributes are amended on a batch-by-batch basis.

6. A method for manufacturing a plurality of products having a plurality of corresponding product attributes, the method comprising the steps of:
(a) providing a first text file including a plurality of amendment entries for amending the product attributes;
(b) reading the first text file and the amendment entries into a scheduling subsystem;
(c) amending the product attributes according to the amendment entries;
(d) determining if any of the amendment entries fails in step (c);
(e) collecting the failed amendment entries in a second text file;
(f) resending the second text file to the scheduling subsystem; and
(g) further amending the product attributes according to the failed amendment entries.

7. The method of claim 6 further comprising the step of repeating the steps (c), (d), (e), (f) and (g).

8. The method of claim 6, the product attributes further comprising product identity, lot identity, commit due time, commit due date, lot order data, lot owner and lot owner department with respect to the products.

9. The method of claim 6, the first text file and the second text file further comprising generally the same text file format.

10. The method of claim 6 further comprising the steps of:
dividing the amendment entries into a plurality of batches; and
amending the product attributes on a batch-by-batch basis.

11. A method for manufacturing a plurality of products having a plurality of corresponding product attributes, the method comprising the steps of:
(h) providing a first text file including a plurality of amendment entries for amending the product attributes;
(i) dividing the amendment entries into a plurality of batches;
(j) importing the first text file and the amendment entries into a scheduling subsystem;
(k) amending the product attributes according to the amendment entries on a batch-by-batch basis;
(l) determining if any of the amendment entries fails in step (c);
(m) collecting the failed amendment entries in a second text file;
(n) importing the second text file to he scheduling subsystem; and
(o) further amending the product attributes according to the failed amendment entries on a batch-by-batch basis.

12. The method of claim 11 further comprising the step of repeating steps (k), (l), (m), (n) and (o).

13. The method of claim 11, the product attributes further comprising product identity, lot identity, commit due time, commit due date, lot order data, lot owner and lot owner department with respect to the products.

14. The method of claim 11, the first text file and the second text file further comprising generally the same text file format.
